(19) United States
(12) Patent Application Publication
(10) Pub. No.: US 2025/0006076 A1
(43) Pub. Date: Jan. 2, 2025

(54) HAPTIC STYLUS TO GUIDE A USER TO HANDWRITE LETTERS

(71) Applicant: INTERNATIONAL BUSINESS MACHINES CORPORATION, Armonk, NY (US)

(72) Inventors: Usman Basha Shaik, Bangalore (IN); Poornima Sekhar, Bangalore (IN); Sriharidatta Sriharidatta, NR Mohalla (IN); Anil Kumar Rajendran, Kollegal (IN)

(21) Appl. No.: 18/342,531

(22) Filed: Jun. 27, 2023

(51) Int. Cl. G09B 11/00; B43K 29/08; G06F 3/01; G06F 3/16; G06T 7/70

(52) U.S. Cl. CPC G09B 11/00; B43K 29/08; G06F 3/016; G06F 3/16; G06T 7/70

(57) ABSTRACT

Provided are a haptic stylus, computer program product, and method to guide a user to handwrite letters. A directive is received to write a selected letter. Vibration commands are generated for the selected letter to control vibrator elements in the haptic stylus to generate haptic feedback to guide the haptic stylus held by the user to form the selected letter on the writing surface when the user moves the haptic stylus on the writing surface.

### BACKGROUND OF THE INVENTION

### 1. Field of the Invention

The present invention relates to a haptic stylus, computer program product, and method to guide a user to handwrite letters.

### 2. Background

Haptic pen styluses for use with touch-screen displays include actuators and a vibrator to provide haptic feedback to users while using the pens to write on the touch-screen display. The haptic pen stylus may provide feedback of user operations on the touch-screen, such as clicking a displayed button, to simulate the impression of a button movement. The purpose of the haptic feedback is to provide an approximation of physical sensations when writing to improve the user experience with writing on a touch-screen display.

### SUMMARY

Provided are a haptic stylus, computer program product, and method to guide a user to handwrite letters. A directive is received to write a selected letter. Vibration commands are generated for the selected letter to control vibrator elements in the haptic stylus to generate haptic feedback to guide the haptic stylus held by the user to form the selected letter on the writing surface when the user moves the haptic stylus on the writing surface.

### BRIEF DESCRIPTION OF THE DRAWINGS

FIGS. 1A and 1B illustrate an embodiment of a haptic stylus to train a student to handwrite letters.

FIG. 2 illustrates an embodiment of a language script pattern for a letter in a language.

FIG. 3 illustrates an embodiment of operations to generate haptic feedback from a haptic stylus to guide a user to properly form letters.

FIG. 4 illustrates an embodiment of operations to verify the user is correctly forming letters with the haptic stylus.

FIG. 5 illustrates an embodiment of operations to guide a user of the haptic stylus to a next line on a page to practice writing a letter.

FIG. 6 is a computing environment in which the components of FIGS. 1A and 1B may be implemented.

### DETAILED DESCRIPTION

Teaching students to handwrite letters is a time-consuming process that requires teachers to monitor and guide students to practice handwriting letters on lined paper to learn to properly form the letters. Many students use visual cues to learn to write letters, such as glancing at a printed letter while practicing writing and visually confirming that the letter they are handwriting matches a printed version of a properly formed letter. However, visually challenged and impaired students cannot rely on such visual cues to guide them in learning how to handwrite letters. Teaching a visually challenged student to write often involves significant teacher intervention to guide the student's hand to train muscle and motor memory to form the letters without the benefit of visual assistance.

Described embodiments provide improvements to educational technology by providing a haptic stylus to train a student to handwrite letters without direct intervention from a teacher. Described embodiments implement specialized computational components and vibrator elements within a body of the haptic stylus to provide haptic feedback to guide a student's hand to learn how to properly form letters. Further, described embodiments provide verification components in the body of the haptic stylus, including an embedded camera, to verify that the student is correctly handwriting the letters.

In further embodiments, to reduce the cost of learning to write, the haptic stylus may include an ink dispenser to guide the student to learn to handwrite letters on paper. This is advantageous over writing systems that utilize a stylus with a computer tablet surface because the cost of a computer tablet is expensive. With the described embodiments that utilize an ink dispenser in the haptic stylus, a computer tablet surface is not needed because the letters may be written on paper. Described embodiments embed the technology to guide and monitor the student handwriting within the body of the haptic stylus or pen the student uses to write on paper. This stylus technology teaches the student to write without requiring the purchase of expensive components, such as a computer tablet.

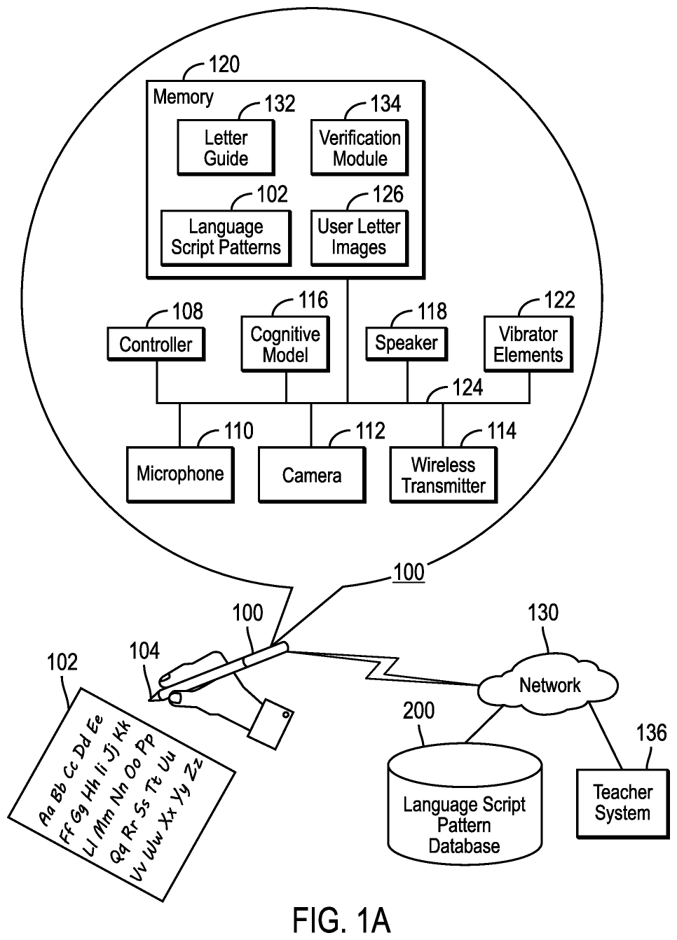

FIGS. 1A and 1B illustrate an embodiment of a haptic stylus 100 used to train a person to write letters on a medium, such as lined paper 102. With respect to FIG. 1A, the haptic stylus 100 may include an ink dispenser on a tip 104 to write letters on the paper 102 or other surface on which ink may be dispensed. The internal components of the haptic stylus 100 include a controller 108, a microphone 110, a camera 112, a wireless transmitter 114, a cognitive model 116, a speaker 118, a memory 120, and vibrator elements 122 that communicate over a bus interface 124, such as a peripheral component interconnect (PCI) bus. The cognitive model 116 may comprise a machine learning model to determine a probability an image captured by the camera 112 of a letter or portion of a letter written by the haptic stylus 100 on the paper 102 is substantially similar to a ground truth image of the letter maintained in language script patterns 200i for language i loaded in the memory 120 or user letter images 126 maintained in the memory 120. The cognitive model 116 may be implemented in an accelerator engine, such as a separate semiconductor device.

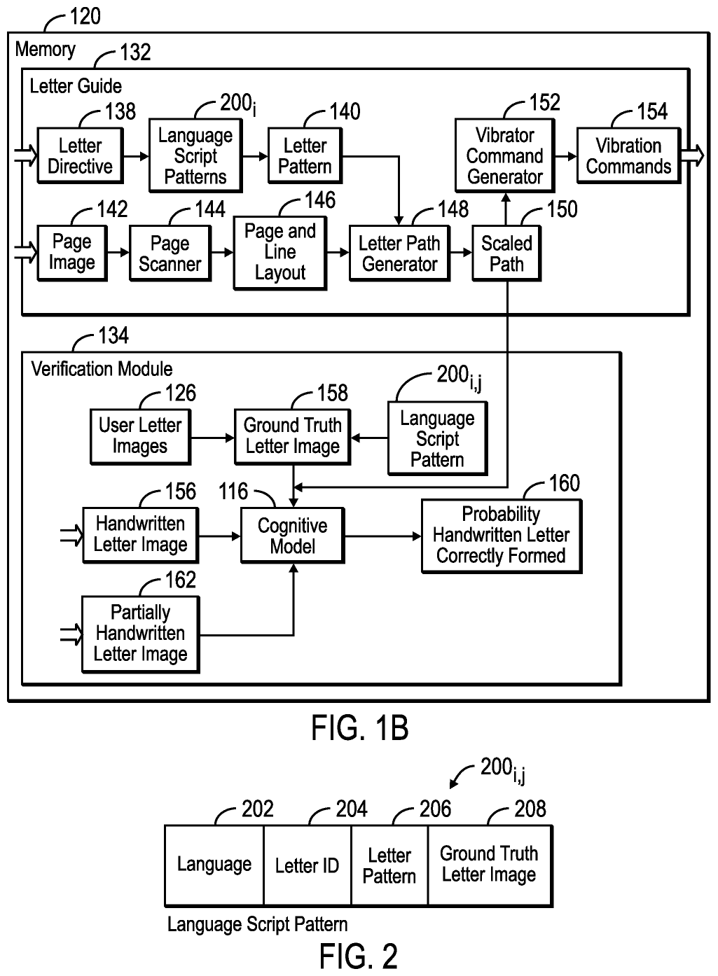

The language script pattern 200; comprises the letters or script patterns for a particular language i downloaded from a language script pattern database 200 from over a network 130 via the wireless transmitter 114 or from another system. The language script pattern database 200 maintains scripts or alphabet patterns for multiple languages for use in the haptic stylus 100 to train a person how to write the letters in a particular language. FIG. 2 is an embodiment of a language script pattern 200_{i, j} for language i and a letter j in language i, and indicates a language i 202; letter j 204 in the language 202; a letter pattern 206, which may comprise a vector of directional coordinates that can be used to form/trace the letter; and a ground truth letter image 208 comprising an image of a well-formed letter 204.

The user letter images 126 comprise letters written by a user that sufficiently approximate well-formed letters 208 from the language script patterns 200_{i, j} with stylistic distinctions specific to the user's handwriting style. The user letter images 126 may be used as ground truth letter images to compare against the letters being written by the user with the haptic stylus 100.

The memory further includes a letter guide 132 and a verification module 134. The letter guide 132 comprises a program that generates vibration commands 154 (FIG. 1B) to control the vibrator elements 122 to guide the haptic stylus 100 to trace a pattern of letter j from the language script pattern 200_{i, j}. The verification module 134, in conjunction with the cognitive model 116 and captured images from the camera 112, determines whether the letters the user has written, using the haptic stylus 100 guiding the user hand, approximate a ground truth letter from the language script patterns 200; or user letter images 126.

The vibrator elements 122 convey tactile sensation through the haptic stylus 100 body using components such as haptic/vibration actuators, linear resonant actuators, rotary vibrators, an impact generator, and vibration motors that create a tactile sensation of movement along the stylus, such as up and down, bidirectional torque movement, and lateral movement. The vibrator elements 122 may be arranged along a longitudinal axis of the haptic stylus housing 100. Some of the vibrator elements 122 may be placed close to a user's fingertips grasping the stylus to amplify the haptic feedback. The haptic stylus 100 may further include a battery (not shown) to supply power, such as a rechargeable battery.

A teacher at a teacher system 136, i.e., remote computing device, may communicate letters to write, over the network 130, to the haptic styluses 100 of students in a classroom or at remote locations to practice writing. The cameras 112 in the haptic styluses 100 may capture images of a letter the students have handwritten with their haptic styluses 100. The wireless transmitter 114 may transmit the captured image of the handwritten letter to the teacher system 136 through the network 130 for the teacher at the teacher system 136 to review and determine further instructions to the students.

FIG. 1B provides an embodiment of the letter guide 132 and the verification module 134. The letter guide 132 receives a letter directive 138 via the microphone 110 or wireless transmitter 114 comprising a command to guide the haptic stylus 100 to form a letter specified in the directive 138. The letter guide 132 determines a letter pattern 140 comprising a pattern 204 specified in the language script pattern 200_{i, j} for the letter j in the directive 138 for language i. The letter guide 132 further receives a page image 142 captured from the camera 112 and inputs into a page scanner 144 that analyzes the page image 142 and outputs a page and line layout 146 identifying a boundary of a page in the page image 142 and lines formed on the page in the page image 142. The letter pattern 140 and page and line layout 146 are inputted into a letter path generator 148 that generates a scaled path 150 comprising the letter pattern 206 scaled to the page and line layout 146 of the page 102 captured in the page image 142. The scaled path 150 may comprise a vector including ordered directional coordinates defining a path for the haptic stylus 100 to be directed via the vibrator elements 122 to form the letter pattern 140. The scaled path 150 is inputted to a vibrator command generator 152 that generates vibration commands 154 to control the vibrator elements 122 to vibrate to guide the haptic stylus 100 in a user hand to form the letter pattern 140 along the scaled path 150.

Verification module 134 receives a handwritten letter image 156, captured by the camera 112, of a letter written by the tip 104 of the haptic stylus 100 as the vibrator elements 122 direct the haptic stylus 100 along a path to form the letter. The handwritten letter image 156 and a ground truth letter image 158 of the letter pattern 140, from the image 208 in the language script pattern 200_{i, j} or from the user letter images 126, are inputted to the cognitive model 116 to determine a probability 160, or other indication, the handwritten letter image 156 correctly approximates the ground truth letter image 158.

The camera 112 may also capture a partially handwritten letter image 162 of a portion of a letter as it is being written by the haptic stylus 100 before completion. The partially handwritten letter image 162 and the ground truth letter image 158 for the letter pattern 140 being formed are inputted to the cognitive model 116 to output a probability 160 the partially handwritten letter image 162 is being correctly formed in progress, i.e., the user is on track for correctly completing the letter pattern 140. The cognitive model 116 may be trained using supervised learning to determine a probability 160 a completed letter pattern and a partially completed handwritten letter are correctly formed.

The memory 120 may comprise a suitable non-volatile storage device, such as a solid state drive, e.g., Flash drive, etc.

The wireless transmitter 114 may comprise a Bluetooth® device or other suitable wireless transmitter/receiver. (Bluetooth is a registered trademark of The Bluetooth Special Interest Group (SIG) throughout the world).

The haptic stylus housing 100 may include one or more cameras 112 whose lens is positioned in a direction to capture a portion of a page 102 on which the haptic stylus 100 tip is positioned while writing.

Generally, program modules, such as the program components 116, 132, 134, 144, 148, 152, among others, may comprise routines, programs, objects, components, logic, data structures, and so on that perform particular tasks or implement particular abstract data types. The program components and hardware devices of the haptic stylus 100 of FIGS. 1A and 1B may be implemented in one or more computer devices, where if they are implemented in multiple computer systems, then the computer systems may communicate over a network.

The program components 116, 132, 134, 144, 148, 152, among others, may be accessed by the controller 108 from the memory 120 to execute. Alternatively, some or all of the program components 116, 132, 134, 144, 148, 152 may be implemented in separate hardware devices, such as Application Specific Integrated Circuit (ASIC) hardware devices.

The functions described as performed by the programs may be implemented as program code in fewer program modules than shown or implemented as program code throughout a greater number of program modules than shown.

In certain embodiments, programs 116, 132, 134, 144, 148, 152, among others, may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used to train a neural network machine learning model, biases at nodes in the hidden layer are adjusted accordingly to produce the output having specified confidence levels based on the input parameters. The programs 116, 132, 134, 144, 148, 152, among others, may be trained to produce their output respective output based on the inputs. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In backward propagation used to train a neural network machine learning model, such as programs 116, 132, 134, 144, 148, 152, among others, margin of errors are determined based on a difference of the calculated predictions and user rankings of the output. Biases (parameters) at nodes in the hidden layer are adjusted accordingly to minimize the margin of error of the error function.

In an alternative embodiment, the components 116, 132, 134, 144, 148, 152, among others, may be implemented not as a machine learning model, but implemented using a rules based system to determine the outputs from the inputs. The components 116, 132, 134, 144, 148, 152, may further be implemented using an unsupervised machine learning model, or machine learning implemented in methods other than neural networks, such as multivariable linear regression models.

The network 130 may comprise the Internet, a Wide Area Network (WAN), wireless network, satellite network, cellular network, etc.

In described embodiments, the haptic stylus 100 includes an ink dispenser on the tip 104 to write letters with ink on the paper 102. In an alternative embodiment, the writing surface may comprise a tablet screen or touch screen and the tip 104 may be formed from capacitors to allow writing on the computer touch screen.

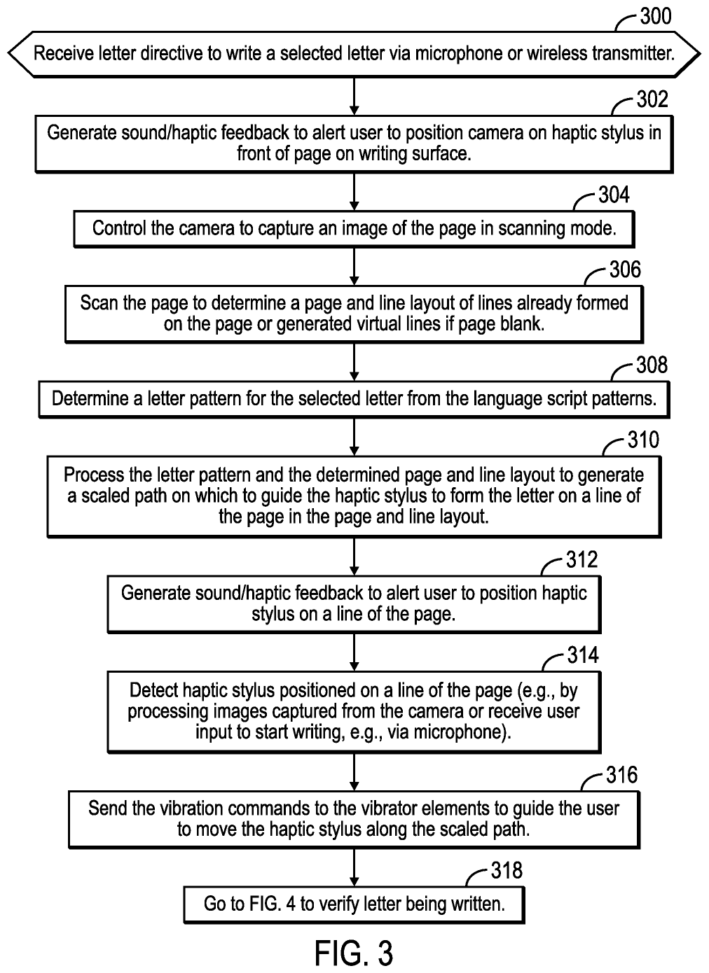

FIG. 3 illustrates an embodiment of operations performed by the letter guide 132 to initiate guidance of the haptic stylus 100 to form a letter. Upon receiving (at block 300) a letter directive 138 to write a selected letter, via the microphone 110 or wireless transmitter 114 from the teacher system 136, the letter guide 132 generates (at block 302) a sound via the speaker 118 or haptic feedback from the vibrator elements 122 to alert the user of the haptic stylus 100 to position the camera 112 in front of a page 102 on the writing surface. The camera 112 is controlled (at block 304) to capture a page image 142 of the page 102 in a scanning mode. The page scanner 144 scans (at block 306) the page 102 to determine a page and line layout 146 of lines already formed on the page 102 or generated virtual lines if the page 102 does not have lines. The letter guide 132 determines (at block 308) a letter pattern 140 for the selected letter from the language script pattern 200_{i, j}, for language i and specified letter j to form.

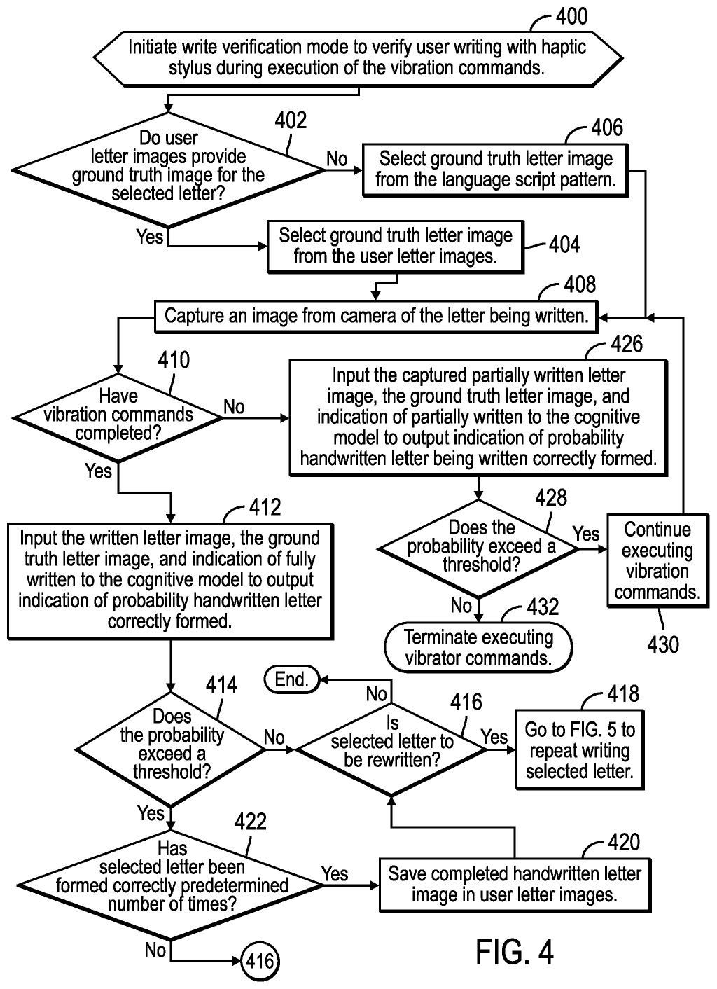

The cognitive model 116 processes (at block 310) input from the letter guide 132 comprising the letter pattern 140 and the determined page and line layout 146 to generate a scaled path 150 comprising a vector of ordered coordinates on which to guide the haptic stylus to form the letter pattern 140 on a line of the page 102. The letter guide 132 may generate (at block 312) a sound via the speaker 118 or haptic feedback from the vibrator elements 122 to alert the user to position the haptic stylus 100 on a line of the page 102. The letter guide 132 may detect (at block 314) the haptic stylus 100 positioned on a line of the page 102, such as by processing images captured from the camera 112 or receive user input to start writing via microphone 110 or other input means. The letter guide 132 sends (at block 316) the vibration commands 154 to the vibrator elements 122 to guide the user to move the haptic stylus 100 along the scaled path 150 on the line of the paper 102. Control then proceeds (at block 318) to FIG. 4 to verify the letter being written by the haptic stylus 100.

With the embodiment of FIG. 3, the internal components of the haptic stylus 100 are used to prompt the user to proceed to a line on the page 102 and then generate vibration commands 154 to control the vibrator elements 122 in the haptic stylus 100 body to guide the haptic stylus 100 in the user hand to form the letter properly. This provides for an automated guide to teach students how to write and form letters. Described embodiments are particularly advantageous and helpful to students visually challenged who cannot rely on their vision to learn how to form letters. The described embodiments use haptic feedback from within the haptic stylus 100 to guide the student's hand to form the letter. This allows the student to gain the muscle and motor memory to form letters from tactile cues that do not require use of vision.

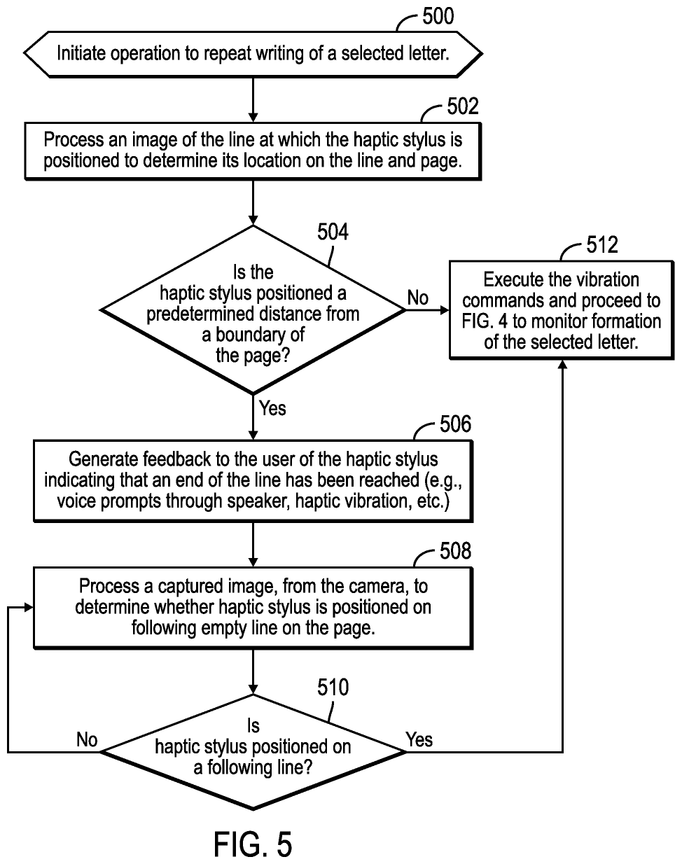

FIG. 4 illustrates an embodiment of operations performed by the verification module 134 to verify the user is forming letters approximately correctly using the haptic stylus 100. Upon initiating (at block 400) a write verification mode to verify the user is forming letters correctly, if (at block 402) the user letter images 126 provide a user style of the letter being formed, then the user letter image 126 for the selected letter is selected (at block 404) as the ground truth letter image 158. Otherwise, if (at block 402) the user letter images 126 do not provide an image for the letter being formed, then the ground truth letter image 208 provided in the language script pattern 200_{i, j} for the selected letter is selected (at block 406) as the ground truth letter image 258. From block 404 or 406, an image is captured (at block 408) from the camera 112. If (at block 410) the execution of the vibration commands 152 has completed, then the captured image comprises a completed handwritten letter image 156. In such case, the handwritten letter image 156, the ground truth letter image 158, and indication of fully written are inputted (at block 412) to the cognitive model 116 to output indication a probability 160, or other indication, the handwritten letter is correctly formed. If (at block 414) the probability 160 does not exceed a threshold for correctly forming the letter, i.e., the letter is not correctly formed, then a determination is made (at block 416) whether the selected letter written is to be rewritten. If so, then control proceeds (at block 418) to FIG. 5 to repeat writing the selected letter, else control ends.

If (at block 414) the probability 160 does exceed the threshold, e.g., 80%, indicating the letter was correctly formed and if (at block 422) the selected letter has been formed correctly a predetermined number of times, then the verification module 134 saves (at block 420) the completed handwritten letter image 156 in the user letter images 126 of images of letters correctly formed in a handwriting style of the user. From block 420 or if (from the NO branch of block 422) the selected letter has not been formed correctly the predetermined number of times, then control proceeds to block 416 to determine whether to further write the letter.

If (at block 410) the vibration commands 154 have not completed when the image was captured, then the captured image comprises a partially handwritten letter image 162. In such case, the partially handwritten letter image 156, the ground truth letter image 158, and indication of partially written are inputted (at block 426) to the cognitive model 116 to output indication a probability 160 the partially handwritten letter is in progress of being formed correctly. If (at block 428) the probability 160 exceeds the threshold, then the vibration commands 154 continue to be executed (at block 430) and control proceeds to block 408 to capture another image to verify the letter being formed. If (at block 428) the probability 160 does not exceed the threshold for correctly forming the letter, i.e., the letter is not correctly formed, then execution of the vibration commands 154 is terminated (at block 432).

With the embodiment of FIG. 4, the formation of completed handwritten letters and partially completed handwritten letters are verified by the haptic stylus 100 to determine whether the user is correctly forming the letter to train the user using haptic feedback to form the letter. Terminating the haptic guidance if the user is not correctly forming a letter does not reinforce the user to continue along an incorrect pattern for writing the letter so the user may train their muscle and motor memory to correctly form the letter.

With the embodiments of FIGS. 3 and 4, the haptic stylus 100 simulates a teacher who would guide the hand of a student with their own hand to form the letter. The haptic stylus 100, like a teacher, would have the user restart and correct formation of a letter if the letter they are in progress of writing is being significantly incorrectly formed.

FIG. 5 illustrates an embodiment of operations performed by the letter guide 132 to repeat writing of a selected letter after the user completes writing the selected letter. Upon initiating (at block 500) an operation to repeat writing the selected letter, the letter guide 132 processes (at block 502) an image, from the camera 112, of the line at which the haptic stylus 100 is positioned, to determine the location of the stylus 100 on the line and page 102. If (at block 504) the haptic stylus 100 is positioned a predetermined distance from a boundary of the page, i.e., too close to the edge to form another letter on the line, then the letter guide 132 generates (at block 506) feedback to the user, of the haptic stylus 100, indicating that an end of the line on the page 102 has been reached, e.g., voice prompt through the speaker 118, haptic feedback through the vibrator elements 122, etc.).

The letter guide 132 processes (at block 508) a captured image, from the camera 112, to determine whether the haptic stylus 100 is positioned on a following empty line on the page 102. If (at block 510) the haptic stylus 100 is not positioned on a following line on the page 102, then control proceeds back to block 508 to continue to wait for the user to reposition the haptic stylus 100, and timeout after a timeout period. If (at block 510) the haptic stylus 100 is positioned on the following line or if (at block 504) the haptic stylus 100 is not positioned the predetermined distance of the boundary of the page 102, i.e., not too close to the edge, then the letter guide 132 executes (at block 512) the vibration commands 154 and proceeds to FIG. 4 to monitor another instance of forming the selected letter.

With the embodiment of FIG. 5, the haptic stylus 100 includes components to guide the user to position the haptic stylus 100 on a next line to continue writing the letter to train the user to form the letter correctly through repetition.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

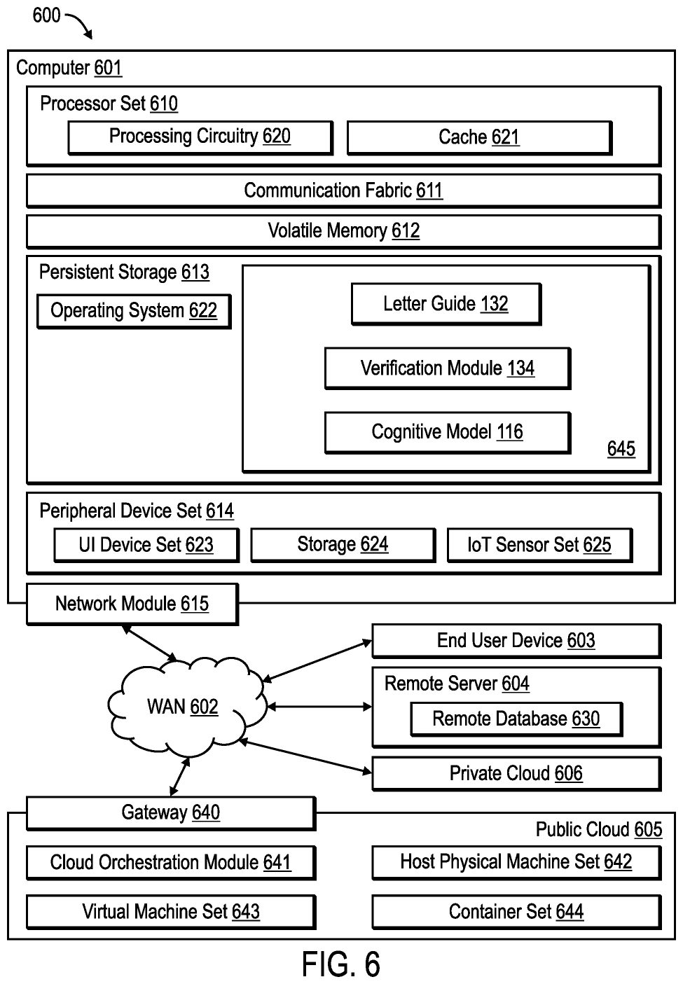

With respect to FIG. 6, Computing environment 600 contains an example of an environment for the execution of at least some of the computer code involved in performing the inventive methods of the haptic stylus 100 to guide a user to form letters with the code in block 645, including the letter guide 132, the verification module 134, and the cognitive model 116 of FIG. 1 In addition to block 645, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 945, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 945 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open source Portable Operating System Interface-type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on. The EUD 604 may comprise additional instances of the haptic stylus 100.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. The remote server 604 may comprise the teacher system 136 in FIG. 1 to provide letter writing directives to students using the haptic stylus 100.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The letter designators, such as i, j are used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A haptic stylus to provide haptic feedback to a user when using the haptic stylus to form letters on a writing surface, comprising:
a controller;
vibrator elements;
a computer readable storage medium comprising program instructions that, when executed by the controller, cause operations, the operations comprising:
receiving a directive to write a selected letter; and
generating vibration commands for the selected letter to control the vibrator elements to generate haptic feedback to guide the haptic stylus held by the user to form the selected letter on the writing surface when the user moves the haptic stylus on the writing surface.

2. The haptic stylus of claim 1, wherein the writing surface comprises paper, further comprising:
a tip of the haptic stylus including an ink dispenser to dispense ink on the paper as the user moves the tip along the writing surface.

3. The haptic stylus of claim 1, further comprising:
a microphone, wherein the program instructions are further executed to perform operations, the operations comprising:
receiving audio input from the microphone; and
processing the audio input to translate the audio input to the directive to write the selected letter.

4. The haptic stylus of claim 1 in communication with a remote computing device, further comprising:
a wireless transmitter to communicate with the remote computing device; and
a camera,
wherein the program instructions are further executed to perform operations, the operations comprising:
receiving, from the remote computing device via the wireless transmitter, the directive to write the selected letter;
capturing, by the camera, an image of the selected letter written with the haptic stylus in response to detecting completing writing the selected letter; and
transmitting the captured image to the remote computing device.

5. The haptic stylus of claim 1, further comprising:
a camera, wherein the program instructions are further executed to perform operations, the operations comprising:
processing a first image, captured by the camera, of the writing surface to determine a page and line layout on the writing surface;
generating a scaled path to form the selected letter within the page and line layout, wherein the vibration commands are generated from the scaled path to guide the haptic stylus along the scaled path within a line of the page and line layout; and
detecting from a second image, captured by the camera, the haptic stylus positioned on the line of the writing surface, wherein the vibration commands are executed in response to detecting the haptic stylus positioned on the line.

6. The haptic stylus of claim 5, wherein the operations further comprise:
processing a third image, captured by the camera, to determine whether the haptic stylus is positioned a predetermined distance from a boundary of the page and line layout; and
generating feedback to the user of the haptic stylus indicating that an end of the line has been reached in response to determining that the haptic stylus is positioned the predetermined distance from the boundary.

7. The haptic stylus of claim 5, wherein the line comprises a first line, and wherein the operations further comprise:
processing a third image, captured by the camera, to determine whether the user has positioned the haptic stylus on a second line of the page and line layout in response to determining that the haptic stylus was moved to an end of the first line; and
generating feedback to the user of the haptic stylus indicating that the haptic stylus has not been positioned on the second line in response to determining that the haptic stylus has not been positioned on the second line.

8. The haptic stylus of claim 1, wherein the operations further comprise:
detecting that the user is moving the haptic stylus in a direction away from a path the haptic feedback is guiding the haptic stylus; and
generating feedback to the user of the haptic stylus indicating that the user is not properly directing the haptic stylus in response to the detecting the user is moving the haptic stylus in a direction away from the path the haptic feedback is guiding the haptic stylus.

9. The haptic stylus of claim 1, further comprising:
a camera;
a cognitive model, implementing machine learning,
wherein the operations further comprise:
capturing an image, by the camera, of a handwritten letter formed by the user moving the haptic stylus guided by the haptic feedback in response to completing the generating the haptic feedback to guide the user to form the selected letter;
inputting the image of the handwritten letter and a ground truth image of the selected letter into the cognitive model to output indication the handwritten letter sufficiently approximates the selected letter; and
generating feedback to the user of the haptic stylus in response to determining that the handwritten letter does not sufficiently approximate the selected letter.

10. The haptic stylus of claim 9, wherein the operations further comprise:
capturing a predetermined number of images of the handwritten letter determined to sufficiently approximate the selected letter; and
saving a last of the captured predetermined number of images to use as the ground truth image of the selected letter to input into the cognitive model to determine whether the handwritten letter sufficiently approximates the selected letter.

11. A computer program product to provide haptic feedback to a user when using a haptic stylus to form letters on a writing surface, wherein the haptic stylus has vibrator elements, wherein the computer program product comprises a computer readable storage medium having program instructions embodied therewith that when executed cause operations, the operations comprising:
receiving a directive to write a selected letter; and
generating vibration commands for the selected letter to control the vibrator elements to generate haptic feedback to guide the haptic stylus held by the user to form the selected letter on the writing surface when the user moves the haptic stylus on the writing surface.

12. The computer program product of claim 11, wherein the haptic stylus includes a microphone, wherein the operations further comprise:
receiving audio input from the microphone on the haptic stylus; and
processing the audio input to translate the audio input to the directive to write the selected letter.

13. The computer program product of claim 11, wherein the haptic stylus includes a camera, wherein the operations comprising:
processing a first image, captured by the camera, of the writing surface to determine a page and line layout on the writing surface;
generating a scaled path to form the selected letter within the page and line layout, wherein the vibration commands are generated from the scaled path to guide the haptic stylus along the scaled path within a line of the page and line layout; and
detecting from a second image, captured by the camera, the haptic stylus positioned on the line of the writing surface, wherein the vibration commands are executed in response to detecting the haptic stylus positioned on the line.

14. The computer program product of claim 11, wherein the operations further comprise:
detecting that the user is moving the haptic stylus in a direction away from a path the haptic feedback is guiding the haptic stylus; and
generating feedback to the user of the haptic stylus indicating that the user is not properly directing the haptic stylus in response to the detecting the user is moving the haptic stylus in a direction away from the path the haptic feedback is guiding the haptic stylus.

15. The computer program product of claim 11, wherein the haptic stylus includes a camera and a cognitive model implementing machine learning, wherein the operations
capturing an image, by the camera, of a handwritten letter formed by the user moving the haptic stylus guided by the haptic feedback in response to completing the generating the haptic feedback to guide the user to form the selected letter;
inputting the image of the handwritten letter and a ground truth image of the selected letter into the cognitive model to output indication the handwritten letter sufficiently approximates the selected letter; and
generating feedback to the user of the haptic stylus in response to determining that the handwritten letter does not sufficiently approximate the selected letter.

16. A method for providing haptic feedback to a user when using a haptic stylus to form letters on a writing surface, comprising:
receiving a directive to write a selected letter; and
generating vibration commands for the selected letter to control vibrator elements to generate haptic feedback to guide the haptic stylus held by the user to form the selected letter on the writing surface when the user moves the haptic stylus on the writing surface.

17. The method of claim 16, wherein the writing surface comprises paper, further comprising:
a tip of the haptic stylus including an ink dispenser to dispense ink on the paper as the user moves the tip along the writing surface.

18. The method of claim 16, further comprising:
processing a first image, captured by a camera, of the writing surface to determine a page and line layout on the writing surface;
generating a scaled path to form the selected letter within the page and line layout, wherein the vibration commands are generated from the scaled path to guide the haptic stylus along the scaled path within a line of the page and line layout; and
detecting from a second image, captured by the camera, the haptic stylus positioned on the line of the writing surface, wherein the vibration commands are executed in response to detecting the haptic stylus positioned on the line.

19. The method of claim 16, further comprising:
detecting that the user is moving the haptic stylus in a direction away from a path the haptic feedback is guiding the haptic stylus; and
generating feedback to the user of the haptic stylus indicating that the user is not properly directing the haptic stylus in response to the detecting the user is moving the haptic stylus in a direction away from the path the haptic feedback is guiding the haptic stylus.

20. The method of claim 16, further comprising:
capturing an image of a handwritten letter, by a camera, formed by the user moving the haptic stylus guided by the haptic feedback in response to completing the generating the haptic feedback to guide the user to form the selected letter;
inputting the image of the handwritten letter and a ground truth image of the selected letter into a cognitive model to output indication the handwritten letter sufficiently approximates the selected letter; and
generating feedback to the user of the haptic stylus in response to determining that the handwritten letter does not sufficiently approximate the selected letter.
